(19) United States
(12) Patent Application Publication
(10) Pub. No.: US 2012/0131027 A1
(43) Pub. Date: May 24, 2012

(54) METHOD AND MANAGEMENT APPARATUS OF DYNAMIC RECONFIGURATION OF SEMANTIC ONTOLOGY FOR SOCIAL MEDIA SERVICE BASED ON LOCALITY AND SOCIALITY RELATIONS

(75) Inventors: Jung Tae KIM, Daejeon (KR); Jong Hoon LEE, Daejeon (KR); Hoon Ki LEE, Daejeon (KR); Eui Hyun PAIK, Daejeon (KR)

(73) Assignee: Electronics and Telecommunications Research Institute, Daejeon (KR)

(21) Appl. No.: 13/192,333

(22) Filed: Jul. 27, 2011

(30) Foreign Application Priority Data
Nov. 24, 2010 (KR) 10-2010-0117713

(51) Int. Cl. G06F 17/30

(52) U.S. Cl. 707/756; 707/E17.005

(57) ABSTRACT

Disclosed are a method and a management apparatus of dynamic reconfiguration of semantic ontology. More specifically, the management apparatus of dynamic reconfiguration of semantic ontology of an exemplary embodiment of the present invention includes: a retrieval engine retrieving metadata stored in a semantic repository; a user interface listing the retrieved metadata; a semantic browser changing the content of the listed metadata on the basis of user input depending on the listed metadata; and an ontology updating unit dynamically reflecting the changed metadata onto ontology associated with the retrieved metadata.

### TECHNICAL FIELD

The present invention relates to a method and a management apparatus of reconfiguration of semantic ontology for changing user's knowledge or experience information which is changed in real time into meaningful formalized information in order to provide a social media service based on locality and sociality relations through ontology.

### BACKGROUND

In general, the semantic web is defined as information and a service on the web and relates to the web extension technology in which the web understands human and machine's requirements for using web contents to satisfy a user.

In addition, the semantic web is based on an XML-based semantic markup language. The simplest format RDF expresses a concept in a triple type of <Subject, Predicate, Object> and is a predetermined set of standards for producing and distributing interoperable contents which can be recognized by the machine.

That is, the semantic web is associated with an infrastructure side, not application programs or services and knowledge expression of schema level through modeling of ontology is essential for constructing an infrastructure.

Meanwhile, ontology relates to the methodology of knowledge expression of relations between resources (data) on the semantic web and resources removed with logical ambiguity and relates to not a formalized knowledge expression method expressed as the existing database but a description logic.

In addition, in ontology modeling, contents can be automatically processed and understood by a machine by applying automation through an agent and deduction for deducing inherent knowledge.

A feature of a semantic web service based on the ontology is a personalization service.

The personalization service is to provide a customized service according to circumstances which users individually require and is based on user's current location and personal information.

The personalization service should be considered because it is important that the ontology which is a formalized expression method of user's locality and sociality relations is expressed and the locality and sociality relations which are dynamically changed are processed in real time.

### SUMMARY

The present invention relates to the technology that provides a social media service based on locality and sociality relations through ontology and the present invention has been made in an effort to provide a method and a management apparatus of dynamic reconfiguration of more intelligent semantic ontology by solving a limit in static storing and updating user information in the related art by providing an automated semantic ontology reconfiguration function required to express information based on locality and sociality relations through updating for reflection onto ontology based on a semantic browser managing ontology metadata stored in a semantic repository and user actions.

An exemplary embodiment of the present invention provides a management apparatus of dynamic reconfiguration of semantic ontology, the apparatus including: a retrieval engine retrieving metadata stored in a semantic repository; a user interface listing the retrieved metadata; a semantic browser changing the content of the listed metadata on the basis of user input depending on the listed metadata; and an ontology updating unit dynamically reflecting the changed metadata onto ontology associated with the retrieved metadata.

The semantic browser may provide the content of the listed metadata in real time.

The semantic browser may perform additional retrieval within a retrieval result to be considered at the time of changing the content of the listed metadata.

The semantic browser may include a manager mode function that dynamically manages user's experience knowledge and information regarding a place which are dynamically changed to be considered at the time of changing the content of the listed metadata.

The semantic browser may provide the listed metadata to a user in a schema structure.

The retrieval engine may automatically convert a retrieval word inputted in a general declarative sentence type into an SPARQL type formalized query type.

Another exemplary embodiment of the present invention provides a management method of dynamic reconfiguration of semantic ontology, the method including: retrieving metadata stored in a semantic repository; listing the retrieved metadata; changing the content of the listed metadata on the basis of user input depending on the listed metadata; and dynamically reflecting the changed metadata onto ontology associated with the retrieved metadata.

In the changing of the content, the content of the listed metadata may be provided in real time.

In the changing of the content, additional retrieval within a retrieval result to be considered at the time of changing the content of the listed metadata may be performed.

The changing of the content may include a manager mode function that dynamically manages user's experience knowledge and information regarding a place which are dynamically changed to be considered at the time of changing the content of the listed metadata.

The semantic browser may provide the listed metadata to a user in a schema structure.

The retrieval engine may automatically convert a retrieval word inputted in a general declarative sentence type into an SPARQL type formalized query type.

According to exemplary embodiments of the present invention, a method and a management apparatus of dynamic reconfiguration of semantic ontology for a social media service based on locality and sociality relations provide the following effects.

First, a more intelligent semantic web-based personalization service by solving a limit in static storing/updating user information in the related art is provided.

Second, retrieval accuracy is improved by updating the user information in real time.

Third, retrieval efficiency is improved by using ontology based metadata.

### BRIEF DESCRIPTION OF THE DRAWINGS

FIG. 1 is a block diagram of a dynamic reconfiguration management apparatus of semantic ontology according to an exemplary embodiment of the present invention;

FIG. 2 is a detailed diagram of a retrieval result list and a semantic browser displayed at the time of selecting each of items of a retrieval result according to an exemplary embodiment of the present invention; and

FIG. 3 is a flowchart for describing a dynamic reconfiguration management method of semantic ontology according to an exemplary embodiment of the present invention.

### DETAILED DESCRIPTION

Hereinafter, exemplary embodiments of the present invention will be described in detail with reference to the accompanying drawings. First of all, it should be noted that in giving reference numerals to elements of each drawing, like reference numerals refer to like elements even though like elements are shown in different drawings. Further, in describing the present invention, well-known functions or constructions will not be described in detail since they may unnecessarily obscure the understanding of the present invention. Hereinafter, the exemplary embodiments of the present invention will be described, but it will be understood to those skilled in the art that the spirit and scope of the present invention are not limited thereto and various modifications and changes can be made.

The exemplary embodiments of the present invention may be implemented through various means. For example, the exemplary embodiments of the present invention may be implemented by hardware including a mobile, a PDA, a computer, and the like, software, or the combinations thereof.

Predetermined terms used in the following description are provided to help understanding the present invention and the use of the predetermined terms may be modified into different forms without departing from the spirit of the present invention.

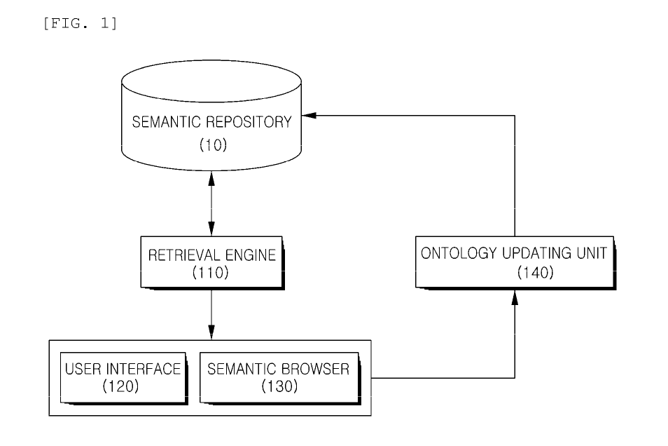

FIG. 1 is a block diagram of a dynamic reconfiguration management apparatus of semantic ontology according to an exemplary embodiment of the present invention.

Referring to FIG. 1, the dynamic reconfiguration management apparatus of semantic ontology includes a retrieval engine 110, a user interface 120, a semantic browser 130, and an ontology updating unit 140.

The retrieval engine 110 retrieves metadata stored in a semantic repository.

Meanwhile, the semantic repository 10 stores user's knowledge or experience information which is changed in real time in order to provide a locality/sociality relation based personalization service.

Herein, the semantic repository 10 may store triple type information based on semantic markup on the basis of an XML.

In detail, the triple type may be used as an RDF<Subject, Predicate, Object> type, but the present invention is not limited thereto.

Further, the retrieval engine 110 may automatically convert a retrieval word inputted in a general declarative sentence type into an SPARQL type formalized query type.

In detail, for example, when the declarative sentence “Retrieve a person who is positioned in Seoul at present.” is inputted, the retrieval engine generates an SPARQL type of “Select ?s where{?s #hasPosition #seoul}”. For this, a list extracting metadata is generated to select the query input data.

The user interface 120 lists the retrieved metadata.

Herein, the user interface 120 provides information to a user and may provide the information through various means.

The semantic browser 130 changes the content of the listed metadata on the basis of user input depending on the listed metadata.

Further, the semantic browser 130 provides the content of the listed metadata in real time.

In addition, the semantic browser 130 includes a manager mode function that dynamically manages user's experience knowledge and information regarding a place which are dynamically changed to be considered at the time of changing the content of the listed metadata.

Besides, the semantic browser 130 provides the listed metadata to the user in a schema structure.

The semantic browser 130 includes arrangement of the retrieval result, additional retrieval in the retrieval result, and deletion and modification input of the retrieval result.

Herein, when the semantic browser 130 will be described in detail, metadata called “kim hasPosition Seoul” which is the retrieval result represents information indicating that Kim is positioned in Seoul at present.

In addition, in the case in which positional information is changed as Kim moves to Pusan, when a portion of the semantic browser 130 corresponding to Seoul is selected, a selectable instance is provided to City class connected to Seoul on an ontology schema.

Herein, in this case, Pusan is also instance information of class City and the user selects Pusan to change the current location of Kim.

The semantic browser 130 may include a manager mode function that dynamically manages and checks the user's experience knowledge and the information regarding the place which are dynamically changed.

In addition, the semantic browser 130 automatically judges constraints set on the ontology schema and may include a user notification function that previously detects an error for user's modification and use which is contrary to conformity.

In detail, a constraints set on the ontology scheme, that “One person cannot be simultaneously positioned at two locations.”, may be automatically judged and in the case in which one person is present at a predetermined location at present, input of metadata associated with a new location may be previously prevented.

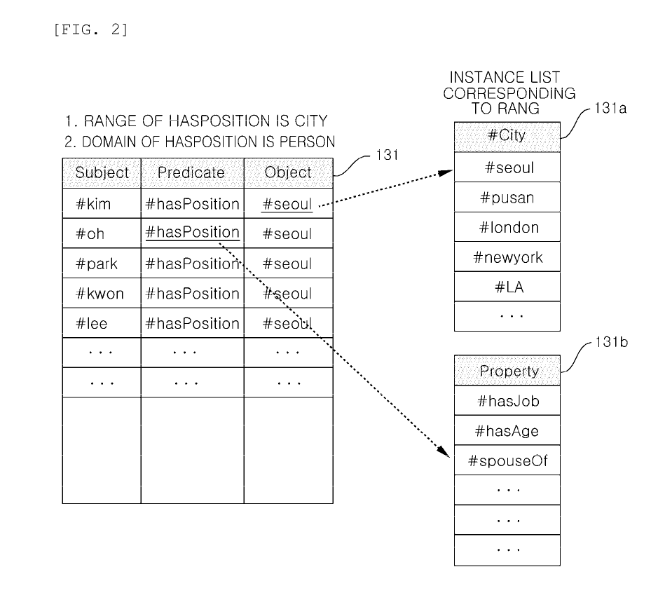

Herein, the semantic browser 130 according to the exemplary embodiment of the present invention will be described in detail with reference to FIG. 2.

Referring to FIG. 2, Hasposition 131 includes City 131a in region Range and Person 131b as a domain.

When category Object in the Hasposition 131 is selected, an instance list which is a sub-category of City 131a is displayed.

Meanwhile, when Predicate is selected, category Property included in corresponding Subject may be automatically generated.

Herein, the semantic browser 130 may provide semantic browsing based on the ontology schema.

The ontology updating unit 140 provides the retrieval result changed from the semantic browser to the ontology.

Further, the ontology updating unit 140 dynamically reflects the changed retrieval result including input, modification, deletion, and the like of the generated metadata to the ontology in real time.

In addition, the ontology updating unit 140 is the module that generates a control language capable of actually changing semantic metadata by inputting a user action message and reflects the generated control language to the ontology.

For example, the ontology updating unit 140 judges information indicating that the existing metadata “U kim positioned seoul” is modified to metadata “kim positioned Pusan” and generates the control language capable of changing the corresponding metadata in real time.

The ontology updating unit 140 may extend the control language by considering other metadata connected to each component of the modified metadata.

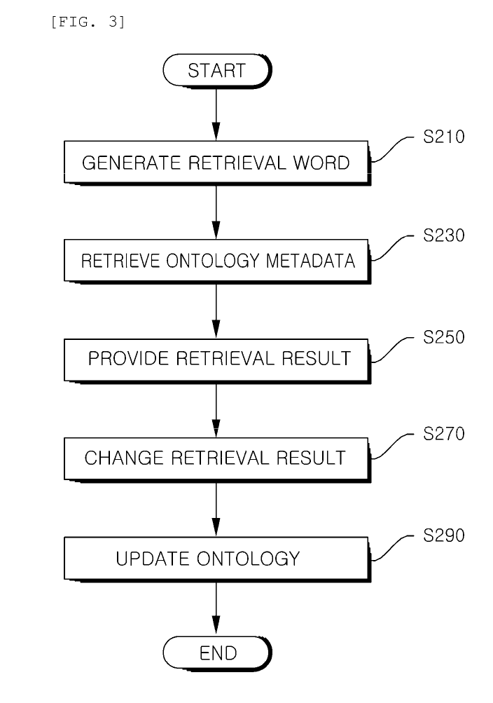

Hereinafter, referring to FIG. 3, a dynamic reconfiguration method of semantic ontology according to an exemplary embodiment of the present invention will be described.

FIG. 3 is a flowchart for describing a dynamic reconfiguration management method of semantic ontology according to an exemplary embodiment of the present invention.

Referring to FIG. 3 in detail, the dynamic reconfiguration method of semantic ontology includes retrieving metadata stored in a semantic repository (S230), listing the retrieved metadata (S250), changing the content of the listed metadata on the basis of user input depending on the listed metadata (S270), and dynamically reflecting the changed metadata onto ontology associated with the retrieved metadata (S290).

Herein, the method may further include converting a retrieval word inputted in a general declarative sentence type into an SPARQL type and automatically converting the converted retrieval word into a formalized query type (S210) before the retrieving.

Further, the method may further include automatically judging constraints set on an ontology schema and previously detecting an error for user modification and use which is contrary to conformity.

The method may further include dynamically managing and checking user's experience knowledge and information regarding a place which are dynamically changed.

Further, in the providing of the retrieval result, an additional retrieval function may be provided within the retrieval result.

Next, the retrieval result changed from the semantic browser may be provided to the ontology in real time.

In addition, in the changing of the content, the content of the listed metadata is provided in real time.

Further, in the changing of the content, additional retrieval within the retrieval result to be considered at the time of changing the content of the listed metadata is performed.

Besides, the changing of the content includes a manager mode function that dynamically manages user's experience knowledge and information regarding a place which are dynamically changed to be considered at the time of changing the content of the listed metadata.

The original object of the method and management apparatus of dynamic reconfiguration of semantic ontology of the present invention relates to a technology to provide a social media service based on locality and sociality relations, but is not limited thereto and the method and management apparatus of dynamic reconfiguration of semantic ontology of the present invention can be applied to any technological field that requires changing of data in real time.

The spirit of the present invention has been just exemplified. It will be appreciated by those skilled in the art that various modifications, changes, and substitutions can be made without departing from the essential characteristics of the present invention. Accordingly, the exemplary embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A management apparatus of dynamic reconfiguration of semantic ontology, the apparatus comprising:
a retrieval engine retrieving metadata stored in a semantic repository;
a user interface listing the retrieved metadata;
a semantic browser changing the content of the listed metadata on the basis of user input depending on the listed metadata; and
an ontology updating unit dynamically reflecting the changed metadata onto ontology associated with the retrieved metadata.

2. The apparatus of claim 1, wherein the semantic browser provides the content of the listed metadata in real time.

3. The apparatus of claim 1, wherein the semantic browser performs additional retrieval within a retrieval result to be considered at the time of changing the content of the listed metadata.

4. The apparatus of claim 1, wherein the semantic browser includes a manager mode function that dynamically manages user's experience knowledge and information regarding a place which are dynamically changed to be considered at the time of changing the content of the listed metadata.

5. The apparatus of claim 1, wherein the semantic browser provides the listed metadata to a user in a schema structure.

6. The apparatus of claim 1, wherein the retrieval engine automatically converts a retrieval word inputted in a general declarative sentence type into an SPARQL type formalized query type.

7. A method of dynamic reconfiguration of semantic ontology, the method comprising:
retrieving metadata stored in a semantic repository;
listing the retrieved metadata;
changing the content of the listed metadata on the basis of user input depending on the listed metadata; and
dynamically reflecting the changed metadata onto ontology associated with the retrieved metadata.

8. The method of claim 7, wherein in the changing of the content, the content of the listed metadata is provided in real time.

9. The method of claim 7, wherein in the changing of the content, additional retrieval within a retrieval result to be considered at the time of changing the content of the listed metadata is performed.

10. The method of claim 7, wherein the changing of the content includes a manager mode function that dynamically manages user's experience knowledge and information regarding a place which are dynamically changed to be considered at the time of changing the content of the listed metadata.
